(19) United States
(12) Patent Application Publication
(10) Pub. No.: US 2016/0181699 A1
(43) Pub. Date: Jun. 23, 2016

(54) ANTENNA FOR WIRELESS COMMUNICATION

(71) Applicant: Universal Scientific Industrial (Shanghai) Co., Ltd., Shanghai (CN)

(72) Inventors: Chung-Hsin Chiang, Shanghai (CN); Kuang-Ting Chi, Shanghai (CN)

(73) Assignee: Universal Scientific Industrial (Shanghai) Co., Ltd., Shanghai (CN)

(21) Appl. No.: 14/805,086

(22) Filed: Jul. 21, 2015

(30) Foreign Application Priority Data
Dec. 23, 2014 (CN) 201410829427.2

(51) Int. Cl. H01Q 9/06; H01Q 1/38; H01Q 5/40

(52) U.S. Cl. CPC H01Q 9/065; H01Q 5/40; H01Q 1/38

(57) ABSTRACT

The present disclosure relates to an antenna structure including a first metal member and a second metal member. The first metal member includes a protruding portion. The second metal member defines a recess portion. The first metal member is separated from the second metal member. The protruding portion of the first metal member extends at least partially into the recess portion of the second metal member. The first metal member and the second metal member are located along a same plane.

### CROSS-REFERENCE TO RELATED PATENT APPLICATIONS

This application claims the benefit of and priority to Chinese Patent Application No. 201410829427.2, filed on Dec. 23, 2014, the content of which is incorporated herein by reference in its entirety.

### BACKGROUND

1. Technical Field

The present disclosure relates to an antenna for wireless communication, and in particular, to a directional radiation antenna for wireless communication.

2. Description of the Related Art

Many electronic products, such as notebook computers, personal digital assistants (PDAs), wireless base stations, and mobile phones, have wireless communication capability, and correspondingly incorporate an antenna for wireless communication. Such an antenna may be incorporated into a radio frequency module.

### SUMMARY

In accordance with an embodiment of this disclosure, an antenna structure includes a first metal member and a second metal member. The first metal member includes a protruding portion. The second metal member defines a recess portion. The first metal member is separated from the second metal member. The protruding portion of the first metal member extends at least partially into the recess portion of the second metal member. The first metal member and the second metal member are located on a same plane.

In accordance with an embodiment of this disclosure, an antenna structure includes a first metal member, a second metal member, a first extension portion, and a second extension portion. The first metal member includes a protruding portion. The second metal member defines a recess portion. The first metal member is separated from the second metal member. The protruding portion of the first metal member extends at least partially into the recess portion of the second metal member. The first extension portion is connected to the first metal member, and the second extension portion is connected to the second metal member. An extension direction of the second extension portion is different from an extension direction of the first extension portion.

In accordance with an embodiment of this disclosure, a wireless communication device includes a substrate including at least one layer, a first antenna including a protruding portion, a second antenna defining a recess portion; and a transceiver circuit connected to at least one of the first antenna and the second antenna. The first antenna is separated from the second antenna. The protruding portion extends at least partially into the recess portion. The first antenna and the second antenna are located on, or within, a same layer of the substrate.

### BRIEF DESCRIPTION OF THE DRAWINGS

FIG. 1A illustrates an antenna structure according to an embodiment of the present disclosure;

FIG. 1B illustrates an antenna structure according to another embodiment of the present disclosure;

FIG. 2 illustrates an antenna structure according to another embodiment of the present disclosure; and

FIG. 3 illustrates simulated results of an antenna structure according to an embodiment of the present disclosure.

FIG. 4 illustrates an example of a wireless communication device including an antenna structure according to an embodiment of the present disclosure.

### DETAILED DESCRIPTION

As electronic products become smaller, the individual components of the electronic products become smaller, including a wireless communication antenna. However, the antenna should retain a bandwidth capability that allows for transmission or reception of large quantities of data. Described in the present disclosure is an antenna structure that may be manufactured in a small size in one or more embodiments, thereby reducing manufacturing costs. The antenna structure provides a communication bandwidth capability that allows for transmission or reception of large quantities of data, thereby also providing an improvement in communication quality.

In one or more embodiments, a feed-point antenna and a ground-point antenna in an antenna structure may be arranged on different layers of a substrate. In one or more embodiments, a balun or a slot may be used to adjust impedance of an antenna structure. In one or more embodiments, however, an improved antenna structure is provided without arranging the feed-point antenna and the ground-point antenna on different layers of a substrate, and without the use of additional components (e.g., a balun) for impedance adjustment; thus, an area of the substrate used for the antenna structure may be reduced.

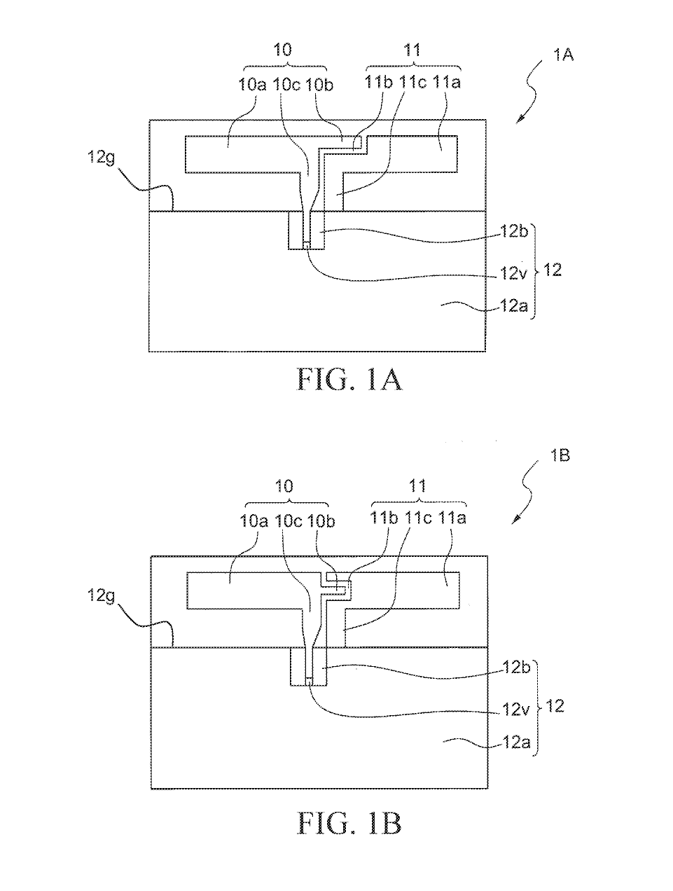

FIG. 1A illustrates a top view of an antenna structure according to one or more embodiments of the present disclosure. As shown in FIG. 1A, the antenna structure 1A includes a first antenna 10, a second antenna 11, and a substrate 12. The antenna structure 1A may be a dipole antenna.

The first antenna 10 includes a first metal member 10a, a protruding portion 10b, and a third metal member 10c. The first metal member 10a and the third metal member 10c are arranged at an angle with respect to each other. In one or more embodiments, the first metal member 10a and the third metal member 10c are substantially perpendicular to each other. The protruding portion 10b may extend outwards from one or both of the first metal member 10a or the third metal member 10c. In one or more embodiments, the protruding portion 10b extends outwards from a side surface of the first metal member 10a; for example, extends towards the right in the orientation illustrated in FIG. 1A. In one or more embodiments, the protruding portion 10b extends outwards from a side surface of the third metal member 10c; for example, extends towards the right in the orientation illustrated in FIG. 1A. The protruding portion 10b and the third metal member 10c are arranged at an angle with respect to each other. In one or more embodiments, the protruding portion 10b and the third metal member 10c are substantially perpendicular to each other.

The first metal member 10a, the protruding portion 10b, and the third metal member 10c may be formed integrally with, or may be electrically connected to, one another, and the first metal member 10a, the protruding portion 10b, and the third metal member 10c may be formed of a same metal, metal alloy, or other conductive material, or may be formed of different respective metals, metal alloys, or other conductive materials through deposition (or other additive technique), etching (or other subtractive technique), lamination, or other techniques.

The second antenna 11 includes a second metal member 11a and a fourth metal member 11c. The second metal member 11a and the fourth metal member 11c are arranged at an angle with respect to each other. In one or more embodiments, the second metal member 11a and the fourth metal member 11c are substantially perpendicular to each other. The second antenna 11 defines a recess portion 11b that may be a recess in one or both of the second metal member 11a or the fourth metal member 11c. In one or more embodiments, the recess portion 11b is a recess in a side surface of the second metal member 11a; for example, a recess in a left surface of the second metal member 11a in the orientation illustrated in FIG. 1A. In one or more embodiments, the recess portion 11b is a recess in a side surface of the fourth metal member 11c; for example, a recess in a left surface of the fourth metal member 11c in the orientation illustrated in FIG. 1A.

The second metal member 11a and the fourth metal member 11c may be formed integrally with, or may be electrically connected to, one another. The second metal member 11a and the fourth metal member 11c may be formed of a same metal, metal alloy, or other conductive material, or may be formed of different respective metals, metal alloys, or other conductive materials through deposition (or other additive technique), etching (or other subtractive technique), lamination, or other techniques.

The first antenna 10 and the second antenna 11 are separated or spaced from each other. The protruding portion 10b of the first antenna 10 extends at least partially into the recess portion 11b of the second antenna 11. By extending the protruding portion 10b partially into the recess portion 11b of the second antenna 11, a total surface area of neighboring surfaces of the first antenna 10 and the second antenna 11 is increased, as compared to an embodiment in which the protruding portion 10b is omitted and the recess portion 11b is not defined. The increased total surface area provided by the use of the protruding portion 10b and the recess portion 11b allows a capability for increasing an induction area of the antenna structure 1A. Thus, a capacitance of the antenna structure 1A may be adjusted, such as by increasing a length or a height of the protruding portion 10b, with a corresponding increase in a length or a height of the recess portion 11b. Further, the adjacency of the protruding portion 10b of the first antenna 10 to the second metal member 11a or the fourth metal member 11c of the second antenna 11 may give rise to a capacitive effect. Thus, a capacitance of the antenna structure 1A may be adjusted, such as by adjusting a distance between the protruding portion 10b of the first antenna 10 and the recess portion 11b of the second antenna 11.

Although an approximately rectangular shape is illustrated for the protruding portion 10b and the recess portion 11b, a rectangular shape is non-limiting, and other polygonal or non-polygonal shapes are encompassed by this disclosure.

As can be seen from the above discussion, the use of the protruding portion 10b and the recess portion 11b allows for flexibility in tuning an impedance of the antenna structure 1A, in that the antenna structure 1A may be modified to implement a change in inductance, a change in capacitance, or both.

Although illustrated in some embodiments of this disclosure as including one protruding portion 10b and one recess portion 11b, the antenna structure 1A (or the antenna structures 1B or 2 described below) may include more than one protruding portion 10b and may define more than one recess portion 11b.

The substrate 12 may be a single-layered or a multi-layered substrate. In one or more embodiments, the substrate 12 may be a circuit board, such as a printed circuit board (PCB), a flexible printed circuit (FPC) board, or another suitable circuit board. In the embodiment illustrated in FIG. 1A, the substrate 12 is a bi-layer substrate, which includes a top layer 12a and a bottom layer 12b. In the embodiment illustrated in FIG. 1A, the first antenna 10 and the second antenna 11 are both located on the top layer 12a of the substrate 12 (e.g., disposed on or embedded into a surface of the top layer 12a). The fourth metal member 11c of the second antenna 11 is electrically connected to the top layer 12a, and the third metal member 10c of the first antenna 10 is electrically connected to the bottom layer 12b by a conductive via 12v.

In the embodiment illustrated in FIG. 1A, the first antenna 10 may be a feed-point antenna, which is electrically connected to a transmission line (not shown) located on the bottom layer 12b. The second antenna 11 may be a ground-point antenna, which is electrically connected to a ground plane of the top layer 12a. For example, a portion 12g of the top layer 12a may be a ground plane. In one or more embodiments, when the antenna structure 1A is used in a wireless communication device, the first antenna 10 may be electrically connected to a transceiver circuit in the communication device, and the second antenna 11 is grounded; therefore, signals in the first antenna 10 and the second antenna 11 are approximately 180° out of phase. In one or more embodiments, the first antenna 10 and the second antenna 11 may be connected in an opposite manner; in other words, the first antenna 10 may be a ground-point antenna, and the second antenna 11 may be a feed-point antenna.

As noted above, the protruding portion 10b may extend outwards from one or both of the first metal member 10a or the third metal member 10c, and the second antenna 11 defines a recess portion 11b that may be a recess of one or both of the second metal member 11a or the fourth metal member 11c. In other words, the protruding portion 10b may be located at different positions along a right side of the remainder of the antenna 10 (the remainder being, for example, the first metal member 10a and the third metal member 10c), and the recess portion 11b may be defined at different positions along a left side of antenna 11. Further, as noted above, sizes and shapes of the protruding portion 10b and the recess portion 11b may vary.

FIG. 1B illustrates a top view of an antenna structure 1B similar to the antenna structure 1A in FIG. 1A, except that a size and a position of the protruding portion 10b of the first antenna 10, and a size and a position of the recess portion 11b of the second antenna 11, are different in FIG. 1B than in FIG. 1A. The relative positions, sizes and shapes of the protruding portion 10b and the recess portion 11b may be designed according to parameters such as a planned operating frequency or a desired bandwidth of the antenna structure 1B.

As can be seen in FIGS. 1A and 1B, the first antenna 10 and the second antenna 11 may be arranged on a same plane or layer of the substrate 12. For example, upper surfaces of the first antenna 10 and the second antenna 11 may be substantially coplanar, and/or lower surfaces of the first antenna 10 and the second antenna 11 may be substantially coplanar. By arranging the first antenna 10 and the second antenna 11 on the same layer, a space occupied by the antenna structure (e.g., 1A or 1B) in the substrate 12 can be reduced.

A distance between a ground and a radiation portion of an antenna may have a lower limit of one quarter of a wavelength of a signal transmitted/received by the antenna (“quarter wavelength”). However, because an impedance value of the antenna structure 1A or 1B can be adjusted by using the protruding portion 10b and the recess portion 11b as described above, a distance between a ground plane of the substrate 12 (e.g., portion 12g) and a radiation portion of the first antenna 10 or the second antenna 11 may be less than a quarter wavelength in one or more embodiments. For example, the top layer 12a may include a ground plane (e.g., portion 12g) that is less than a quarter wavelength distance from the first metal member 10a and the second metal member 11a used as radiation portions. Such a distance reduction (e.g., to less than a quarter wavelength) may reduce a size of the substrate 12 used by the antenna structure 1A or 1B.

As noted above, the substrate 12 may be a single-layered or a multi-layered substrate. For example, substrate 12 may be a six-layered substrate, where a ground plane is located on one or more of the first to third layers, and an antenna structure 1A or 1B is located on one or more of the fourth to sixth layers. In this example, a distance between the antenna structure 1A or 1B and the ground plane may be increased by arranging the first antenna 10 and the second antenna 11 on a same layer (e.g., both are located on the sixth layer) separated from the ground plane (e.g., located on the first layer). In such a manner, interference of the ground plane on the antenna structure 1A or 1B can be reduced.

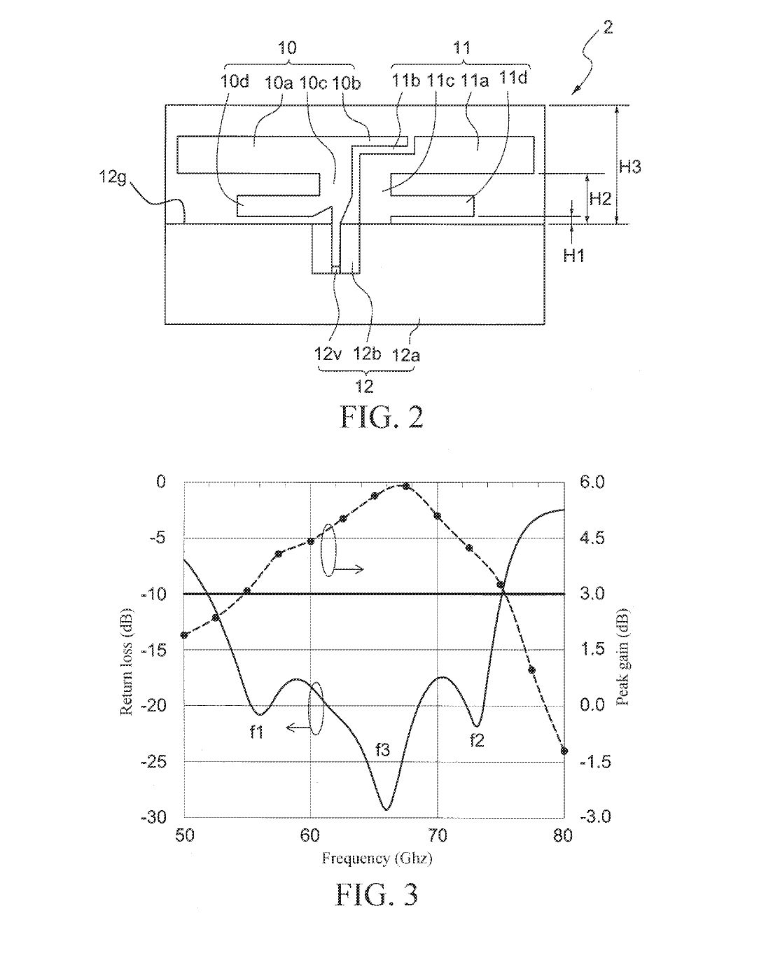

FIG. 2 illustrates a top view of an antenna structure according to another embodiment of the present disclosure. The antenna structure 2 disclosed in FIG. 2 is similar to the antenna structure 1A disclosed in FIG. 1A, except that the antenna structure 2 in FIG. 2 further includes a first extension portion 10d and a second extension portion 11d.

The first extension portion 10d is electrically connected to, or formed integrally with, the third metal member 10c of the first antenna 10, and extends outwards at an angle from the third metal member 10c. In one or more embodiments, the first extension portion 10d extends outwards at an angle of approximately 90° relative to the third metal member 10c. In one or more embodiments, the first extension portion 10d extends in a direction substantially parallel to the direction that the protruding portion 10b extends. In other embodiments, the direction of extension of the first extension portion 10d is not parallel to the direction of extension of the protruding portion 10b.

The second extension portion 11d is electrically connected, or formed integrally with, to the fourth metal member 11c of the second antenna 11, and extends outwards at an angle from the fourth metal member 11c. In one or more embodiments, the second extension portion 11d extends outwards at an angle of approximately 90° relative to the fourth metal member 11c. In one or more embodiments, an angle of the second extension portion 11d relative to the fourth metal member 11c is substantially the same as an angle of the first extension portion 10d relative to the third metal member 10c. By way of non-limiting example, as illustrated in FIG. 2, an extension direction of the second extension portion 11d is substantially opposite from an extension direction of the first extension portion 10d. In one or more embodiments, an angle of the second extension portion 11d relative to the fourth metal member 11c is different from an angle of the first extension portion 10d relative to the third metal member 10c.

As noted above, surfaces of the first antenna 10 and the second antenna 11 may be substantially coplanar. Thus, the first antenna 10 and the second antenna 11 may be disposed on, or fully or partially within, a single-layered substrate, or disposed on, or fully or partially within, a single layer of a multi-layered substrate. In one or more embodiments, portions of the first antenna 10 and the second antenna 11 may be disposed on, or fully or partially within, different surfaces or layers of a single-layered or multi-layered substrate.

In one or more embodiments, the first metal member 10a and the protruding portion 10b of the first antenna 10, in combination with the second metal member 11a and the recess portion 11b of the second antenna 11, form a resonant structure, such that signals transmitted from the antenna structure 2 may be transmitted/received at a first resonant frequency. Further, the first extension portion 10d of the first antenna 10 and the second extension portion 11d of the second antenna 11 form another resonant structure to transmit/receive signals from the antenna structure 2 at a second resonant frequency. In addition, the first metal member 10a, the third metal member 10c, and the first extension portion 10d of the first antenna 10 form another resonant structure to transmit/receive signals from the antenna structure 2 at a third resonant frequency.

In general, bandwidth of an antenna can be increased by increasing a number of resonant frequencies of the antenna. Thus, the antenna structure 2 with three resonant frequencies has greater bandwidth as compared to an antenna structure having less than three resonant frequencies.

Similar to the description above with respect to the antenna structure 1A of FIG. 1A, an impedance of the antenna structure 2 may be adjusted by adjusting the protruding portion 10b of the first antenna 10 and the recess portion 11b of the second antenna 11. Additionally, the impedance of the antenna structure 2 may be adjusted by adjusting a size or position of the first extension portion 10d and/or the second extension portion 11d.

As noted above, a distance between a radiation portion of an antenna and a ground plane of a substrate may have a lower limit of a quarter wavelength of a signal transmitted/received by the antenna. However, because an impedance value of the antenna structure 2 may be adjusted by using the protruding portion 10b and the recess portion 11b, and by using the first extension portion 10d and the second extension portion 11d, a distance between a ground plane of the substrate 12 and the first extension portion 10d and the second extension portion 11d may be less than a quarter wavelength.

In an example, the top layer 12a of the substrate 12 includes a ground plane, such as the portion 12g of the top layer 12a. A distance H1 between the portion 12g and the first extension portion 10d (or between the portion 12g and the second extension portion 11d) may be about 0.05 millimeter (mm); and a distance H2 between the portion 12g and the first metal member 10a (or between the portion 12g and the second metal member 11a) may be about 0.32 mm. In this example, a width H3 of an antenna clearance zone on the substrate 12 may be about 0.7 to about 0.75 mm. As can be seen, an antenna structure according to this disclosure (e.g., antenna structure 1A, 1B or 2) provides for implementation on a small area of a substrate. The small area used on the substrate allows for more components to be disposed on or in the substrate, or allows for the antenna structure to be spaced farther away from other components (providing for improved transmission/reception quality). Thus, the small area used on the substrate allows for one or more of improved flexibility of circuit distribution, reduced size (and corresponding manufacturing cost) of the substrate, and improved quality of signal transmission/reception.

FIG. 3 discloses test results of an antenna structure according to the embodiment of the antenna structure 2 illustrated in FIG. 2. In FIG. 3, the solid line represents a relationship between an antenna operating frequency (horizontal axis, in gigahertz (GHz)) and a return loss (left vertical axis, in decibels (dB)). The dashed line represents a relationship between the antenna operating frequency and a peak gain (right vertical axis, in dB). Three resonant frequencies f1, f2, and f3 can be seen from the negative peaks in return loss as shown by the solid line. Correspondingly, as seen by the broad gain peak in dotted line, the antenna exhibits good gain characteristics (greater than or equal to approximately 3 dB peak gain) over approximately 36.2% of the frequency band 50-80 GHz. By comparison, an antenna design without the protruding portion 10b, the recess portion 11b, the first extension portion 10d and the second extension portion 11d exhibits good gain characteristics over approximately 16% of the frequency band 50-80 GHz. In this comparison, the antenna structure 2 provides an improvement in bandwidth of more than double. Accordingly, transmission speed and signal quality may both be improved.

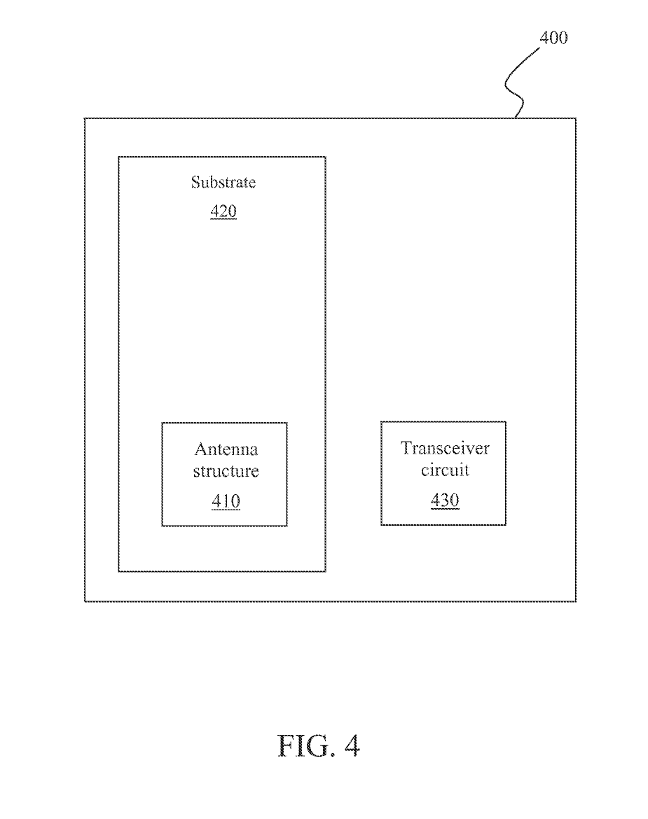

FIG. 4 illustrates an example of a wireless communication device 400 including an embodiment of an antenna structure 410 in accordance with the present disclosure. The antenna structure 410 may be, for example, one of the antenna structures 1A, 1B or 2 illustrated respectively in FIGS. 1A, 1B and 2. The antenna structure 410 is located on, or within, a layer of a substrate 420, which may be single-layered or multi-layered. The wireless communication device 400 further includes a transceiver circuit 430 connected to the antenna structure 410. For example, the antenna structure 410 may include a first antenna 10 and a second antenna 11, and the transceiver circuit 430 may be connected to at least one of the first antenna 10 and the second antenna 11. In one or more embodiments, the antenna structure 410 includes a first antenna 10 electrically connected to the transceiver circuit 430, and a second antenna 11 that is grounded. In one or more embodiments, the transceiver circuit 430 is positioned on, or formed on or in, the substrate 420.

As used herein and not otherwise defined, the terms “about,” “approximately” and “substantially” are used to describe and account for small variations. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, the terms “substantially perpendicular” or “approximately 90° ” can refer to 90°±10°, such as 90°±5°, 90°±4°, 90°±3°, 90°±2°, 90°±1°, 90°±0.5°, 90°±0.1°, or 90°±0.05°, the term “substantially parallel” can refer to 0°±10°, such as 0°±5°, 0°±4°, 0°±3°, 0°±2°, 0°±1°, 0°±0.5°, 0°±0.1°, or 0°±0.05°, and, more generally, the terms “substantially” or “approximately” preceding an angle can refer to that angle ±10°, such as ±5°, ±4°, ±3°, ±2°, ±1°, ±0.5°, ±0.1°, or ±0.05°.

Two surfaces can be deemed to be coplanar or substantially coplanar if a displacement between the two surfaces is no greater than 10 μm, no greater than 5 μm, no greater than 2 μm, no greater than 1 μm, or no greater than 0.5 μm.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily be drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An antenna structure, comprising
a first metal member including at least one protruding portion; and
a second metal member defining at least one recess portion, the first metal member being separated from the second metal member;
wherein the protruding portion extends at least partially into the recess portion; and
wherein the first metal member and the second metal member are located along a same plane.

2. The antenna structure of claim 1, further comprising a third metal member and a fourth metal member, wherein the third metal member is connected to the first metal member, and the fourth metal member is connected to the second metal member.

3. The antenna structure of claim 2, wherein the third metal member and the first metal member are arranged at an angle with respect to each other, and the fourth metal member and the second metal member are arranged at an angle with respect to each other.

4. The antenna structure of claim 1, further comprising a multi-layered substrate, wherein the first metal member and the second metal member are located on, or within, a same layer of the multi-layered substrate.

5. The antenna structure of claim 1, wherein the protruding portion and the recess portion are arranged to provide a capacitive effect.

6. The antenna structure of claim 1, wherein the first metal member and the second metal member are arranged to transmit signals having an approximately 180° phase shift with respect to each other.

7. The antenna structure of claim 1, wherein the antenna structure is a dipole antenna.

8. An antenna structure, comprising
a first metal member including at least one protruding portion;
a second metal member defining at least one recess portion, the first metal member being separated from the second metal member, and the protruding portion extending partially into the recess portion;
a first extension portion connected to the first metal member; and
a second extension portion connected to the second metal member, an extension direction of the second extension portion being different from an extension direction of the first extension portion.

9. The antenna structure of claim 8, further comprising a third metal member and a fourth metal member, wherein the first extension portion is connected to the first metal member by the third metal member, and the second extension portion is connected to the second metal member by using the fourth metal member.

10. The antenna structure of claim 9, wherein the first metal member, the third metal member, and the first extension portion form a resonant structure.

11. The antenna structure of claim 8, wherein the first metal member, the second metal member, the first extension portion and the second extension portion are located along a same plane.

12. The antenna structure of claim 8, further comprising a multi-layered substrate, wherein the first metal member, the second metal member, the first extension portion and the second extension portion are located on a same layer of the multi-layered substrate.

13. The antenna structure of claim 12, wherein a distance between a ground plane of the substrate and at least one of the first extension portion and the second extension portion is less than one quarter of a wavelength of a signal transmitted by the antenna.

14. The antenna structure of claim 12, wherein a distance between a ground plane of the substrate and at least one of the first extension portion and the second extension portion is less than 0.05 millimeter.

15. The antenna structure of claim 8, wherein the first metal member and the protruding portion, together with the second metal member and the recess portion, form a resonant structure.

16. The antenna structure of claim 8, wherein the first extension portion and the second extension portion form a resonant structure.

17. The antenna structure of claim 8, wherein the antenna structure is a dipole antenna.

18. A wireless communication device, comprising:
a substrate including at least one layer;
a first antenna including a protruding portion;
a second antenna defining a recess portion; and
a transceiver circuit connected to at least one of the first antenna and the second antenna,
wherein the first antenna is separated from the second antenna, and the protruding portion extends at least partially into the recess portion; and
the first antenna and the second antenna are located on, or within, a same layer of the substrate.

19. The wireless communication device of claim 18, wherein the first antenna is electrically connected to the transceiver circuit and the second antenna is grounded.

20. The wireless communication device of claim 18, wherein the first antenna includes a first extension portion and the second antenna includes a second extension portion, wherein an extension direction of the second extension portion is different from an extension direction of the first extension portion.
